(19) United States
(12) Patent Application Publication
(10) Pub. No.: US 2021/0082427 A1
(43) Pub. Date: Mar. 18, 2021

(54) INFORMATION PROCESSING APPARATUS AND INFORMATION PROCESSING METHOD

(71) Applicant: SONY CORPORATION, TOKYO (JP)

(72) Inventor: TAKUYA FUJITA, KANAGAWA (JP)

(21) Appl. No.: 17/040,532

(22) PCT Filed: Jan. 22, 2019
(86) PCT No.: PCT/JP2019/001872

§ 371 Date: Sep. 22, 2020

(30) Foreign Application Priority Data
Mar. 30, 2018 (JP) 2018-067461

(51) Int. Cl. G10L 15/22; G10L 15/08; G06F 3/16

(52) U.S. Cl. CPC G10L 15/22; G06F 3/16; G10L 15/08

(57) ABSTRACT

[Problem] To determine right and wrong of a response to an input voice with high accuracy. [Solution] Provided is an information processing apparatus including an information processing unit that determines whether to perform a response process on an input voice on the basis of at least one of a style of the input voice and a style of an output voice. Further, provided is an information processing method including determining, by a processor, whether to perform a response process on an input voice on the basis of at least one of a style of the input voice and a style of an output voice.

### FIELD

The present disclosure relates to an information processing apparatus and an information processing method.

### BACKGROUND

In recent years, devices that detect voices spoken by users and perform response processes on the spoken voices have been in widespread use. Further, in the devices as described above, a technique for detecting only a voice that is spoken by a user with intention to enjoy a response process has been proposed. For example, Patent Literature 1 discloses a technology for determining whether to perform a response process on an input voice on the basis of a distance to a user.

### CITATION LIST

### Patent Literature

Patent Literature 1: JP 2017-144521 A

### SUMMARY

### Technical Problem

However, a factor that needs to be taken into account in determining right and wrong of execution of a response process is not limited to a distance to a user. Therefore, in the technology described in Patent Literature 1, in some circumstances, it may be difficult to accurately determine right and wrong of a response to an input voice.

Therefore, in the present disclosure, an information processing apparatus and an information processing method capable of determining right and wrong of a response to an input voice with high accuracy are proposed.

### Solution to Problem

According to the present disclosure, an information processing apparatus is provided that includes: an intelligent processing unit configured to determine whether to perform a response process on an input voice on the basis of at least one of a style of the input voice and a style of an output voice.

Moreover, according to the present disclosure, an information processing method is provided that includes: determining, by a processor, whether to perform a response process on an input voice on the basis of at least one of a style of the input voice and a style of an output voice.

### Advantageous Effects of Invention

As described above, according to the present disclosure, it is possible to determine right and wrong of a response to an input voice with high accuracy.

Meanwhile, the effects described in this specification are not limitative. That is, with or in the place of the above effects, any of the effects described in this specification or other effects that may be recognized from the present specification may be achieved.

### BRIEF DESCRIPTION OF DRAWINGS

FIG. 1 is a block diagram illustrating a configuration example of an information processing system according to one embodiment of the present disclosure.

FIG. 2 is a block diagram illustrating a functional configuration example of an information processing terminal according to one embodiment.

FIG. 3 is a block diagram illustrating a functional configuration example of an information processing server according to one embodiment.

FIG. 4 is a diagram illustrating an example of determination on right and wrong of a response based on a content of an input voice according to one embodiment.

FIG. 5 is a diagram illustrating an example of determination on right and wrong of a response based on a voice behavior that is estimated from a style of an input voice according to one embodiment.

FIG. 6 is a diagram illustrating an example of determination on right and wrong of a response based on a similarity with a voice style that is significantly detected in a predetermined environment according to one embodiment.

FIG. 7 is a diagram illustrating an example of determination on right and wrong of a response based on the similarity with the voice style that is significantly detected in the predetermined environment according to one embodiment.

FIG. 8 is a diagram illustrating an example of determination on right and wrong of a response based on a style of an input voice and a style of output information according to one embodiment.

FIG. 9 is a diagram illustrating an example of determination on right and wrong of a response based on a content of input and a content of output according to one embodiment.

FIG. 10 is a diagram illustrating an example of determination on right and wrong of a response based on a style of an input voice, a content of the input voice, a style of an output voice, and a content of the output voice according to one embodiment.

FIG. 11 is a diagram illustrating another example of determination on right and wrong of a response based on a style of an input voice and a content of the input voice according to one embodiment.

FIG. 12 is a diagram illustrating an example of determination on right and wrong of a response based on a context according to one embodiment.

FIG. 13 is a diagram illustrating an example of determination on right and wrong of a response based on a context and a content of an input voice according to one embodiment.

FIG. 14 is a diagram illustrating an example of determination on right and wrong of a response based on a context and a content of an input voice according to one embodiment.

FIG. 15 is a diagram illustrating an example of determination on right and wrong of a response based on a context and a content of an input voice according to one embodiment.

FIG. 16 is a diagram illustrating an example of determination on right and wrong of a response based on a context and a content of an input voice according to one embodiment.

FIG. 17 is a diagram illustrating an example of determination on right and wrong of a response based on a context and a content of an input voice according to one embodiment.

FIG. 18 is a diagram illustrating an example of determination on right and wrong of a response based on a context and a content of an input voice according to one embodiment.

FIG. 19 is a flowchart illustrating the flow of operation performed by the information processing server 20 according to one embodiment.

FIG. 20 is a diagram illustrating a hardware configuration example of the information processing server according to one embodiment of the present disclosure.

### DESCRIPTION OF EMBODIMENTS

Preferred embodiments of the present disclosure will be described in detail below with reference to the accompanying drawings. In this specification and the drawings, structural elements that have substantially the same functions and configurations will be denoted by the same reference symbols, and repeated explanation of the structural elements will be omitted.

In addition, hereinafter, explanation will be given in the following order.

1. Embodiment
1.1. Overview
1.2. System configuration example
1.3. Functional configuration example of information processing terminal 10
1.4. Functional configuration example of information processing server 20
1.5. Determination on right and wrong of response
1.6. Specific examples of determination on right and wrong of response
1.7. Flow of operation

2. Hardware configuration example

3. Conclusion

### 1. Embodiment

<<1.1. Overview>>

First, an overview of one embodiment of the present disclosure will be described. As described above, in recent years, various devices that detect voices spoken by users and perform response processes on the spoken voices have been in widespread use. Examples of the above-described devices include a voice agent device.

Here, the voice agent device is a collective term of devices that provide various functions through voice interaction with users. For example, the voice agent device is able to give a reply using artificial voice with respect to an inquiry that is made by a user by voice, and execute various functions based on an instruction that is given by the user by voice.

Meanwhile, in the voice agent device, it is important to accurately accept only a spoken voice intended by a user and accurately reject a voice that is not intended by the user.

Examples of the voice that is not intended by the user include various voices that are output by devices, such as a television device, a radio, an audio player, and other agent devices. Further, examples of the voice that is not intended by the user include spoken voices, such as conversations with other persons and self-talk, that are spoken voices of the user but are not intended to be input to the agent device.

As a technique of detecting the voice intended by the user with high accuracy, for example, the technology described in Patent Literature 1 as described above may be adopted. However, in the technology described in Patent Literature 1 in which right and wrong of a response is determined based on the distance to the user, circumstances in which the voice that is not intended by the user as described above is not accurately rejected may frequently occur. Examples of the above-described circumstances include a circumstance in which the user makes a conversation with another person near the agent device, and a circumstance in which a voice that is output by a different device is input while the user is present near the agent device.

Therefore, there is a demand for a technique that is universally applicable to various circumstances and that is able to determine right and wrong of a response process with respect to an input voice with high accuracy.

A technical idea according to the present disclosure has been conceived in view of the foregoing situations, and makes it possible to determine right and wrong of a response to an input voice with high accuracy. To cope with this, an information processing apparatus that realizes an information processing method according to one embodiment of the present disclosure has a feature to widely determine rejection or acceptance of an input voice on the basis of a content of the input voice, a style of the input voice, a content of output information, a style of the output information, various contexts, or the like.

Here, the content of the input voice as described above includes a type of a recognized command (domain goal), a recognized text, an interpreted intention of speech, and the like.

Further, the style of the input voice as described above widely includes prosodic information and the like. Specifically, the style of the input voice includes voice volume (amplitude, power), voice pitch (fundamental frequency), voice sound (frequency spectrum), rhythm (voice tone), quantity, an input timing, and the like. Furthermore, the style of the input voice may include information on a voice input direction (an angle in a horizontal direction, an angle in a vertical direction), a distance to a sound source, and the like.

Moreover, the content of the output information as described above include various kinds of sound information, visual information, and operation. Here, examples of the sound information as described above include a content of an output voice, a musical composition, a BGM, and a type of a sound effect. Furthermore, the visual information as described above may be an image, a text, a luminous expression using an LED, or the like. Moreover, the operation as described above may include, for example, a gesture or the like.

Furthermore, in the case of visual information for example, the style of the output information as described above includes an output timing, a size and contrast of display, and the like. Moreover, in the case of sound information, the same factors as those adopted in the style of the input voice as described above, an output timing, or an output mode as will be described later may be included. Furthermore, in the case of operation, a timing, a size, a speed, or the like of the operation is included.

Moreover, the context as described above includes various states related to a device, a person who is present in a surrounding area, an environment, and the like. The context related to the device includes, for example, whether a Push To Talk (PTT) button is pressed, whether a predetermined time has not elapsed since recognition of a Wake Up Word (WUW), and the like.

Furthermore, the context related to the device may include various kinds of setting related to input and output of information. Examples of the setting as described above include output modal (screen display or sound output), voice output setting, and voice input setting. Meanwhile, the voice output setting may include setting for a connection of an external device, such as a speaker, an earphone, or a Bluetooth (registered trademark) connection, sound volume, and mute setting. The voice input setting may include setting for a connection of an external device, such as a microphone, mute setting, and the like.

Moreover, the context related to the device includes specification information, such as a model number and a manufacturing date, in addition to the factors as described above.

Furthermore, the context related to a person widely includes, for example, detection information, such as the number of persons in a room, and recognition information, such as an expression, a line of sight, and a behavior. Meanwhile, examples of the behavior to be recognized include behaviors, such as standing, sitting, sleeping, walking, running, dancing, phone calling, making a conversation with another person.

Moreover, the context related to a person may include attribute information, such as an age or a gender, on a detected person, and information on classification as to whether the person is a registered user or not.

Furthermore, as the context related to an environment, coordinates of a current location of the device or a category of the current location may be used. Examples of the category of the current location include a home, outdoors, a train (a type, such as subway or a bullet train, or a degree of congestion), a vehicle, a ship, and an airplane.

Thus, examples of the factors that may be used for determination on right and wrong of a response according to the present embodiment have been described above. According to the information processing method of the present embodiment, by taking into account various factors as described above, it is possible to accurately accept only voice input that is intended by a user and execute various actions at the time of acceptance. Furthermore, according to the information processing method of the present embodiment, it is possible to accurately reject voice input that is not intended by a user and correctly execute an action at the time of rejection. Meanwhile, the actions according to the present embodiment need not always be exhibited, but include various kinds of processing in the device. Furthermore, in the information processing apparatus according to the present embodiment, no action may be executed as a result of determination on right and wrong of a response.

Meanwhile, in the following explanation, a case will be mainly described in which the technical idea according to the present disclosure is applied to determination on right and wrong of a response to an input voice; however, the technical idea according to the present disclosure is not limited to this example, and may be widely applied to a device that performs some kind of processing based on input from a user. For example, the technical idea according to the present disclosure may be applied to a device that performs processing based on input of a gesture.

<<1.2. System Configuration Example>>

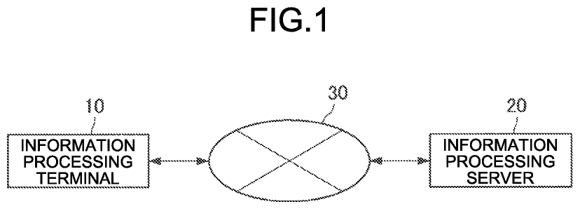

First, a configuration example of an information processing system according to one embodiment of the present disclosure will be described. FIG. 1 is a block diagram illustrating a configuration example of the information processing system according to the present embodiment. With reference to FIG. 1, the information processing system according to the present embodiment includes an information processing terminal 10 and an information processing server 20. Further, the information processing terminal 10 and the information processing server 20 are connected to each other via a network 30 so as to be able to communicate with each other.

(Information Processing Terminal 10)

The information processing terminal 10 according to the present embodiment is an information processing apparatus that makes voice interaction with a user under the control of the information processing server 20. The information processing terminal 10 according to the present embodiment is realized by, for example, a smartphone, a tablet, a wearable device, a general-purpose computer, or a dedicated device of a stationary type or an autonomous mobile type.

(Information Processing Server 20)

The information processing server 20 according to the present embodiment is an information processing apparatus that determines whether to perform a response process on an input voice on the basis of various factors as described above.

(Network 30)

The network 30 has a function to connect the information processing terminal 10 and the information processing server 20. The network 30 may include a public line network, such as the Internet, a telephone network, or a satellite communication network, various Local Area Networks (LANs) and Wide Area Networks (WANs) including Ethernet (registered trademark), and the like. Further, the network 30 may include a dedicated line network, such as Internet Protocol-Virtual Private Network (IP-VPN). Furthermore, the network 30 may include a radio communication network, such as Wi-Fi (registered trademark) or Bluetooth (registered trademark).

Thus, the configuration example of the information processing system according to the present embodiment has been described above. Meanwhile, the configuration described above with reference to FIG. 1 is a mere example, and the configuration of the information processing system according to the present embodiment is not limited to this example. For example, the functions included in the information processing terminal 10 and the information processing server 20 according to the present embodiment may be implemented by a single apparatus. The configuration of the information processing system according to the present embodiment may be modified flexibly in accordance with specifications or operation.

<<1.3. Functional Configuration Example of Information Processing Terminal 10>>

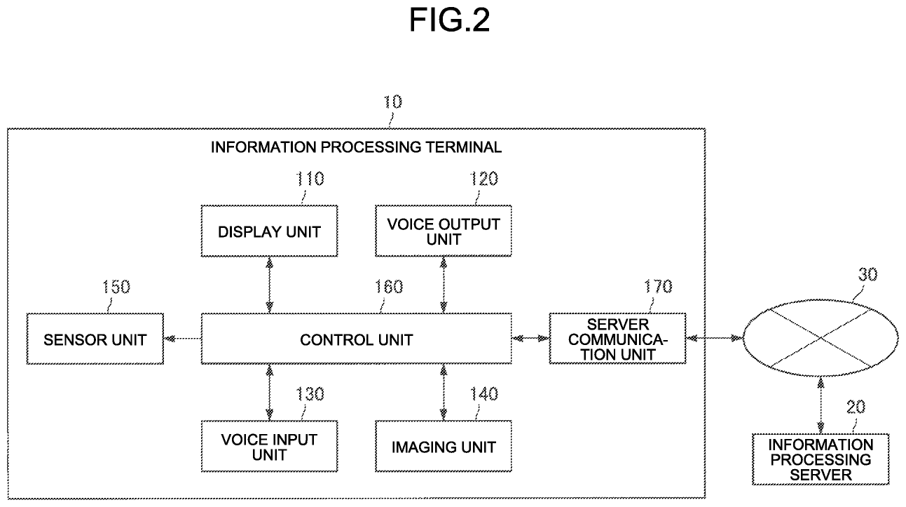

Next, a functional configuration example of the information processing terminal 10 according to the present embodiment will be described. FIG. 2 is a block diagram illustrating the functional configuration example of the information processing terminal 10 according to the present embodiment. With reference to FIG. 2, the information processing terminal 10 according to the present embodiment includes a display unit 110, a voice output unit 120, a voice input unit 130, an imaging unit 140, a sensor unit 150, a control unit 160, and a server communication unit 170.

(Display Unit 110)

The display unit 110 according to the present embodiment has a function to output visual information, such as an image or a text. For example, the display unit 110 according to the present embodiment displays visual information as a response to an input voice under the control of the information processing server 20.

To cope with this, the display unit 110 according to the present embodiment includes a display device or the like for presenting the visual information. Examples of the display device as described above include a Liquid Crystal Display (LCD) device, an Organic Light Emitting Diode (OLED) device, and a touch panel. Further, the display unit 110 according to the present embodiment may output the visual information by using a projection function.

(Voice Output Unit 120)

The voice output unit 120 according to the present embodiment has a function to output various sounds including voices. For example, the voice output unit 120 according to the present embodiment outputs, by voice, a reply to an input voice under the control of the information processing server 20. To cope with this, the voice output unit 120 according to the present embodiment includes a voice output device, such as a speaker or an amplifier.

(Voice Input Unit 130)

The voice input unit 130 according to the present embodiment has a function to collect sound information, such as speech of a user or a surrounding sound that occurs around the information processing terminal 10. The voice input unit 130 according to the present embodiment includes a microphone for collecting the sound information.

(Imaging Unit 140)

The imaging unit 140 according to the present embodiment has a function to capture an image of a user or a surrounding environment. Image information captured by the imaging unit 140 may be used by the information processing server 20 for user behavior recognition, user state recognition, environmental recognition, and the like. The imaging unit 140 according to the present embodiment includes an imaging device capable of capturing an image. Meanwhile, the image as described above includes a still image and a moving image.

(Sensor Unit 150)

The sensor unit 150 according to the present embodiment has a function to collect various kinds of sensor information on a surrounding environment and a user. The sensor information collected by the sensor unit 150 may be used by the information processing server 20 for user behavior recognition, user state recognition, environmental recognition, and the like. The sensor unit 150 includes, for example, an infrared sensor, an ultraviolet sensor, an acceleration sensor, a gyro sensor, a geomagnetic sensor, an illumination sensor, a proximity sensor, a fingerprint sensor, a sensor for acquiring a shape of clothes, a Global Navigation Satellite System (GNSS) signal receiver, a radio signal receiver, and the like.

(Control Unit 160)

The control unit 160 according to the present embodiment has a function to control each of the components included in the information processing terminal 10. For example, the control unit 160 controls activation and deactivation of each of the components. Further, the control unit 160 inputs a control signal generated by the information processing server 20 to the display unit 110 and the voice output unit 120. Furthermore, the control unit 160 according to the present embodiment may have the same functions as those of an intelligent processing unit 230 of the information processing server 20 to be described later. Similarly, the control unit 160 may have the same functions as those of a voice recognition unit 210, a context recognition unit 220, and an output control unit 240 of the information processing server 20.

(Server Communication Unit 170)

The server communication unit 170 according to the present embodiment has a function to perform information communication with the information processing server 20 via the network 30. Specifically, the server communication unit 170 transmits the sound information collected by the voice input unit 130, the image information captured by the imaging unit 140, and the sensor information collected by the sensor unit 150 to the information processing server 20. Further, the server communication unit 170 receives a control signal related to a response process from the information processing server 20.

Thus, the functional configuration example of the information processing terminal 10 according to the present embodiment has been described above. Meanwhile, the configuration described above with reference to FIG. 2 is a mere example, and the functional configuration of the information processing terminal 10 according to the present embodiment is not limited to this example. For example, the information processing terminal 10 according to the present embodiment need not always include all of the components as illustrated in FIG. 2. Further, as described above, the control unit 160 according to the present embodiment may have the same functions as those of the voice recognition unit 210, the context recognition unit 220, the intelligent processing unit 230, and the output control unit 240 of the information processing server 20. The functional configuration of the information processing terminal 10 according to the present embodiment may be modified flexibly in accordance with specifications or operation.

<<1.4. Functional Configuration Example of Information Processing Server 20>>

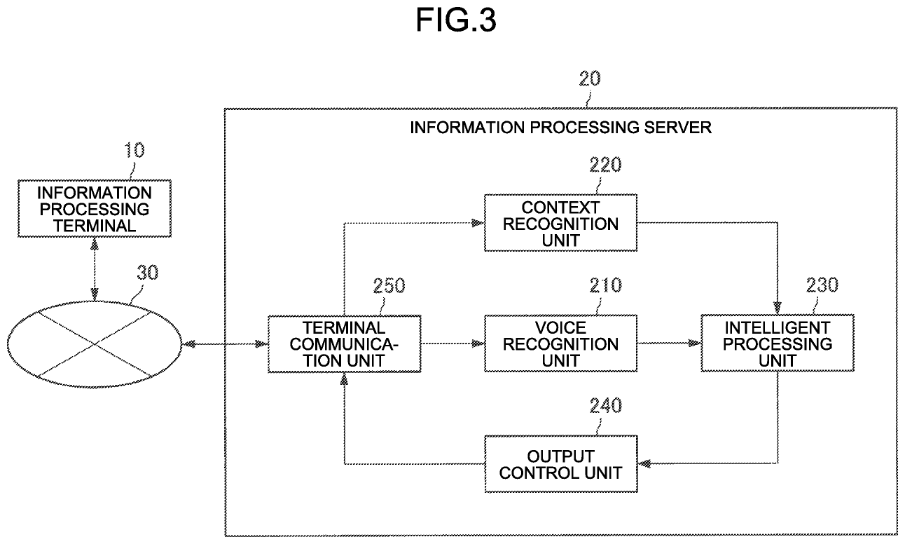

Next, a functional configuration example of the information processing server 20 according to the present embodiment will be described. FIG. 3 is a block diagram illustrating the functional configuration example of the information processing server 20 according to the present embodiment. With reference to FIG. 3, the information processing server 20 according to the present embodiment includes the voice recognition unit 210, the context recognition unit 220, the intelligent processing unit 230, the output control unit 240, and a terminal communication unit 250.

(Voice Recognition Unit 210)

The voice recognition unit 210 according to the present embodiment performs a voice recognition process on the basis of a voice collected by the information processing terminal 10. Meanwhile, the voice recognition unit 210 according to the present embodiment may have a function to convert a voice into a text and a function to perform semantic interpretation based on the text.

(Context Recognition Unit 220)

The context recognition unit 220 according to the present embodiment has a function to recognize various contexts as described above on the basis of the sound information, the image information, and the sensor information collected by the information processing terminal 10. For example, the context recognition unit 220 may recognize a context, such as a behavior and a location of a user, an orientation of the information processing terminal 10, a degree of congestion in a surrounding area (how many people are present in the surrounding area), or the like. Meanwhile, examples of a method of calculating the degree of congestion as described above include calculation based on the number of people that appear in an image, calculation based on a component that is derived from a human and that is included in a sound, and calculation based on a degree of congestion of channels related to radio communication.

(Intelligent Processing Unit 230)

The intelligent processing unit 230 according to the present embodiment has a function to determine whether to perform a response process on an input voice on the basis of the content of the input voice, the style of the input voice, the content of the output information, the style of the output information, and the context. Meanwhile, the response process according to the present embodiment indicates provision of a function that is intended by a user on the basis of a voice that is intentionally input by the user. That is, the response process according to the present embodiment indicates various actions that are executed when the intelligent processing unit 230 determines acceptance of the input voice. In contrast, when the intelligent processing unit 230 according to the present embodiment determines that the input voice is not intended by the user, the intelligent processing unit 230 may reject the input voice and control execution of actions at the time of rejection in some cases; however, it is assumed that the actions in this case are not included in the response process as described above. Details of the functions of the intelligent processing unit 230 according to the present embodiment will be separately described in detail later.

(Output Control Unit 240)

The output control unit 240 according to the present embodiment has a function to control output of response information by the information processing terminal 10, on the basis of the response process that is determined by the intelligent processing unit 230.

(Terminal Communication Unit 250)

The terminal communication unit 250 according to the present embodiment performs information communication with the information processing terminal 10 via the network 30. For example, the terminal communication unit 250 receives the sound information, the image information, the sensor information, and the like from the information processing terminal 10. Further, the terminal communication unit 250 transmits, to the information processing terminal 10, a control signal that is related to output control of response information generated by the output control unit 240.

Thus, the functional configuration example of the information processing server 20 according to the present embodiment has been described above. Meanwhile, the configuration as described above with reference to FIG. 3 is a mere example, and the functional configuration of the information processing server 20 according to the present embodiment is not limited to this example. For example, the configuration as described above may be realized by a plurality of devices in a distributed manner. Further, as described above, the functions of the information processing terminal 10 and the information processing server 20 may be implemented by a single apparatus. The functional configuration of the information processing server 20 according to the present embodiment may be modified flexibly in accordance with specifications or operation.

<<1.5. Determination on Right and Wrong of Response>>

Determination on right and wrong of a response according to the present embodiment will be described in detail below. First, here, a general method of inputting a voice to a device that has a voice interaction function will be described.

The general method of inputting a voice to a device that has the voice interaction function may be, for example, a method using PTT, a method using a wake up word, and a method using both of the wake up word and beamforming.

In the method using PTT, a device starts to perform a voice recognition process when a user presses a button for starting voice input. In this case, the device continues to receive voice input until a timing at which the user finishes speaking or a timing at which the user removes a finger or the like from the button.

However, in the method using PTT, the user is required to press the button before performing voice input, which is cumbersome. At the same time, the method is based on the assumption that the user has a device with the button at hand.

Furthermore, in the method using a wake up word, a device starts to perform a voice recognition process when a user speaks a wake up word that is set in advance. In this case, the device accepts a voice that is input following the wake up word.

However, in the method using the wake up word, the user is required to speak the wake up word every time before the user inputs a voice. In addition, in general, it is necessary to use, as the wake up word, a word that is not used by coincidence in daily conversations in order to prevent erroneous input; therefore, in some cases, the user may feel difficulty in speaking the wake up word.

Moreover, in the method using both of a wake up word and beamforming, a device sets beamforming in a direction in which a user has spoken the wake up word, and accepts a voice input from the set direction for a predetermined period of time.

However, this method is also based on the assumption that the wake up word is used, which leads to the same cumbersomeness and difficulty as described above.

In contrast, according to the information processing method of the present embodiment, it is possible to determine right and wrong of a response with high accuracy without pressing the button and speaking the wake up word, so that it is possible to reduce load on a user.

Meanwhile, the information processing method according to the present embodiment may be used together with, for example, the wake up word and the beamforming as described above. In this case, by firstly determining right and wrong of a response based on the wake up word or the beamforming, and thereafter determining right and wrong of the response again using the information processing method according to the present embodiment, it is possible to largely improve accuracy of the determination on right and wrong of the response. In the following description, an exemplary case will be explained in which the information processing method according to the present embodiment is not used together with the wake up word and the beamforming.

As described above, the intelligent processing unit 230 according to the present embodiment has the function to determine whether to perform a response process on an input voice on the basis of the content of the input voice, the style of the input voice, the content of the output information, the style of the output information, and the context.

The intelligent processing unit 230 according to the present embodiment is able to accurately detect only an input voice that is intended by a user and perform a response process as intended by the user by using one or a combination of the above-described factors.

For example, the intelligent processing unit 230 according to the present embodiment may determine right and wrong of a response by using only the style of the input voice. Specifically, the intelligent processing unit 230 according to the present embodiment is able to determine whether the input voice has been input with the intention of performing the response process on the basis of the style of the input voice, and determine whether to perform the response process on the basis of a result of the determination.

In this case, for example, the intelligent processing unit 230 according to the present embodiment may identify a voice behavior that has become a cause of input of the input voice on the basis of the style of the input voice, and determine whether to perform the response process on the basis of the voice behavior.

Here, the voice behavior according to the present embodiment may be various behaviors that are performed by persons with voice production. The voice behavior includes, for example, normal speech, singing, reading aloud, emotional expression, and non-verbal speech (voice percussion or the like).

The normal speech as described above includes instructions, requests (asking), queries (questions), greetings, calling, nodding, fillers, standard speech other than those as described above, and the like.

Furthermore, the singing as described above includes singing of songs in various genres, such as pop music, popular songs, ballad, folk songs, rhythm and blues, rock, heavy metal, lap, and opera.

Moreover, the reading aloud as described above may include reading aloud of stories or the like, practice in pronunciation of words, naniwabushi, practice in acting, and the like.

Furthermore, the emotional expression as described above includes laughter, a cry, a rallying cry, a shout, a cheer, a scream, and the like.

In this manner, the voice behavior includes various behaviors, but only a part of the voice behaviors in normal speech is assumed as being intended for a response process. Therefore, if an identified voice behavior is not determined as being intended for the response process, the intelligent processing unit 230 according to the present embodiment rejects the input voice and need not perform the response process.

For example, if the voice behavior that is identified based on the style of the voice is singing, the intelligent processing unit 230 may determine that the voice of the user is not intended for the response process and reject the voice. Further, the same applies to a case in which the voice behavior is reading aloud, emotional expression, and other kinds of non-verbal speech.

With the above-described function of the intelligent processing unit 230 according to the present embodiment, even when the voice is produced by the user, if it is estimated that the response process is not expected, it is possible to reject the voice and prevent the response process that is not expected by the user from being erroneously performed.

Furthermore, the intelligent processing unit 230 is also able to estimate a specific sound source by using an estimation history of voice behaviors based on input voices that are input from the specific sound source, and use a result of the estimation for determination on right and wrong of a response. For example, if only a voice behavior of “singing” is estimated from input voices that are input from a specific sound source, the intelligent processing unit 230 may estimate that the specific sound source is an audio player and subsequently reject input voices from the specific sound source.

In contrast, if a voice behavior of “filler” accounts for a predetermined percent or more of all behaviors detected from a specific sound source, the intelligent processing unit 230 may estimate that the specific sound source is not a television device but is highly likely to be a person who is actually present around the information processing terminal 10 (an input voice is not likely to be spoken by an announcer), and use the input voice for subsequent determination on right and wrong of a response.

Meanwhile, the intelligent processing unit 230 according to the present embodiment may identify various voice behaviors by, for example, decomposing input waveforms of the input voice into frames, and extracting a feature amount for each of the frames. Examples of the feature amount as described above include power, fundamental frequency (F0), a zero crossing rate, Mel-frequency cepstral coefficient (MFCC), and a spectrum shape.

Thus, determination on right and wrong of a response based on the voice behaviors according to the present embodiment has been described above. Next, determination on right and wrong of a response based on a phonological feature according to the present embodiment will be described. In the above description, the case has been explained in which the intelligent processing unit 230 according to the present embodiment determines right and wrong of a response based on the voice behavior that is identified from the style of the input voice.

In contrast, even if the same voice behavior is performed, a phonological feature may be changed depending on circumstances in which speech is made. For example, even if a voice behavior is “normal speech”, the phonological feature is changed between when the speech is made directly to a party (including the information processing terminal 10) that is present in the same place and when the speech is made to a party on the other end of a telephone or the like. Furthermore, even if the speech is made to a party present in the same place, the phonological feature may be changed depending on whether the number of parties is one or more (for example, presentation or the like).

Therefore, the intelligent processing unit 230 according to the present embodiment may determine whether the style of the input voice is similar to a voice style that is significantly detected in a predetermined environment, and determine whether to execute a response process on the basis of a result of the determination.

More specifically, if the phonological feature that is extracted from the style of the input voice is similar to a phonological feature of a voice that is significantly detected in a predetermined environment, the intelligent processing unit 230 according to the present embodiment rejects the input voice and need not perform a response process.

Here, the voice style that is significantly detected in the predetermined environment as described above indicates a distinctively characteristic voice style that can hardly be observed in circumstances other than a predetermined scene and professions. This voice style corresponds to, for example, a characteristic voice style spoken by an announcer or the like, which is different from those of ordinary persons.

For example, if the phonological feature that is extracted from the voice style of the input voice is similar to the phonological feature of the voice style of the announcer, the intelligent processing unit 230 according to the present embodiment may estimate that the input voice is not speech of the user, but speech of a news announcer output from a television device or the like, and reject the input voice.

Meanwhile, the predetermined scene and professions as described above include, in addition to the news announcer, announcement at a station or in a train, a bus tour guide, a character in a drama or an animation, campaign speech, acting such as theatrical performance, comic storytelling, kabuki, a synthetic voice, a robot, and the like.

Thus, determination on right and wrong of a response based on the phonological feature according to the present embodiment has been described above. Next, determination on right and wrong of a response based on emotion estimation according to the present embodiment will be described. The intelligent processing unit 230 according to the present embodiment may determine right and wrong of a response based on, for example, an emotion that is estimated from the voice style of the input voice.

In general, it is assumed that a user who interacts with the agent device inputs a voice without getting emotional as compared to a case in which the user talks with another person. Therefore, if a degree of the emotion estimated from the style of the input voice exceeds a threshold for example, the intelligent processing unit 230 according to the present embodiment may determine that the response process is not expected by the input voice.

Examples of the emotion as described above include joy, anger, sadness, pleasure, fear, and excitement.

As described above, the intelligent processing unit 230 according to the present embodiment is able to perform various kinds of analysis from only the voice style of the input voice, and determine right and wrong of a response with high accuracy on the basis of a result of the analysis. Further, the intelligent processing unit 230 is able to further improve accuracy of determination by combining a plurality of analysis results as described above.

Meanwhile, the intelligent processing unit 230 according to the present embodiment is able to realize higher-level determination on right and wrong of a response by using the content of the input voice, the content of the output information, the style of the output information, and various contexts in combination of the style of the input voice. As described above, the output information as described above includes an output voice, visual information to be output, operation to be output, and the like. In the following, an exemplary case in which the intelligent processing unit 230 determines right and wrong of a response on the basis of the content of the output voice and the style of the output voice will be mainly described.

In the following, specific examples of determination on right and wrong of a response realized by the intelligent processing unit 230 according to the present embodiment on the basis of one or a combination of the above-described factors will be described.

<<1.6. Specific Examples of Determination on Right and Wrong of Response>>

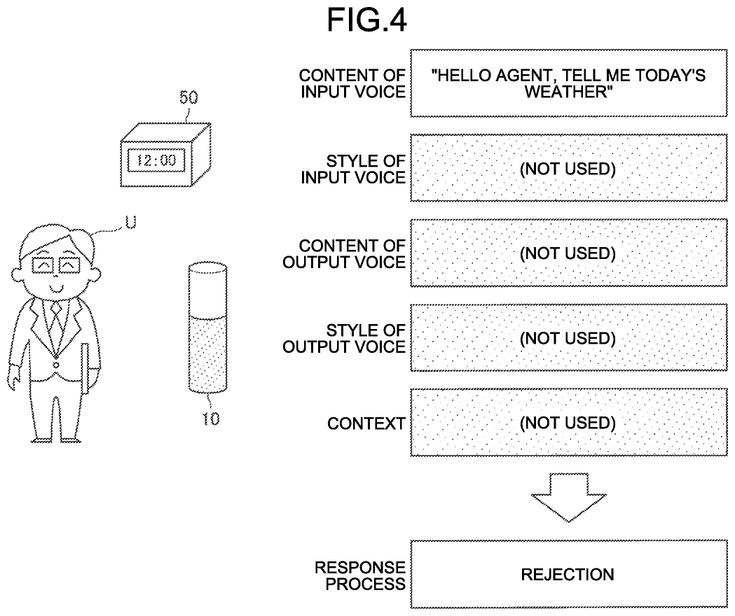

First, an exemplary case in which the intelligent processing unit 230 according to the present embodiment determines right and wrong of a response using only the content of the input voice will be described. FIG. 4 is a diagram illustrating an example of determination on right and wrong of a response based on the content of the input voice according to the present embodiment.

In FIG. 4, one example is illustrated in which a user U performs voice input to a different agent device 50 other than the information processing terminal 10. In this case, the content of the input voice includes a wake up word, such as “Hello agent” as illustrated on the right side in the figure, with respect to the different agent device 50.

In this manner, if the content of the input voice includes the wake up word for executing a function of a different terminal, the intelligent processing unit 230 rejects the input voice and need not perform a response process.

According to the above-described function of the intelligent processing unit 230 of the present embodiment, it is possible to prevent an input voice, such as a request or an instruction, with respect to a different agent device from being erroneously accepted, and prevent a response process that is not expected by a user from being performed.

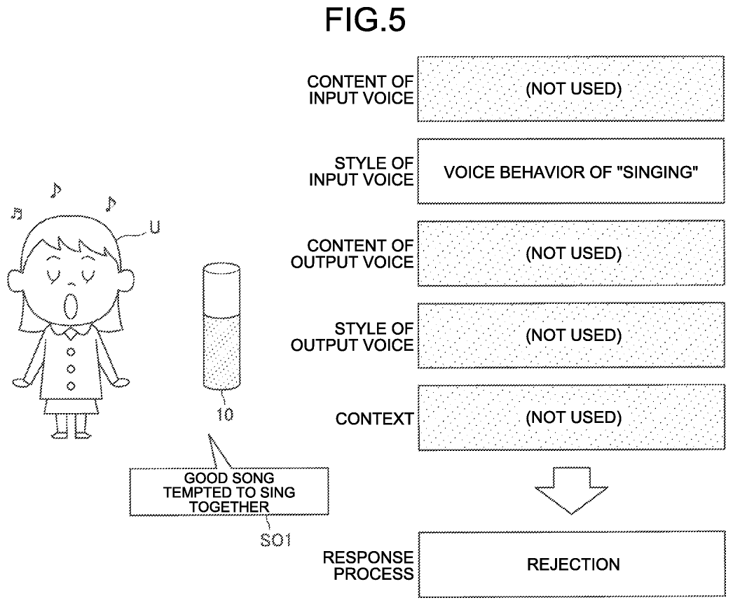

Furthermore, FIG. 5 is a diagram illustrating an example of determination on right and wrong of a response based on a voice behavior that is estimated from the style of the input voice according to the present embodiment. In FIG. 5, an exemplary case is illustrated in which the user U is singing in the vicinity of the information processing terminal 10. In this case, the intelligent processing unit 230 according to the present embodiment is able to identify a voice behavior of “singing” from the style of the input voice as illustrated on the right side in the figure.

In this case, because the voice behavior of “singing” is generally not recognized as being intended for a response process, the intelligent processing unit 230 rejects the input voice and need not perform a response process.

Meanwhile, when rejecting the input voice as described above, the intelligent processing unit 230 may cause the information processing terminal 10 to output feedback related to the rejection of the input voice. In this case, the intelligent processing unit 230 is able to explicitly or inexplicitly indicate a cause of the rejection of the input voice to the user.

In the example illustrated in FIG. 5, the intelligent processing unit 230 causes the information processing terminal 10 to output voice speech SO1 of “Good song, tempted to sing together”. With this feedback, the user U is able to naturally learn that it is impossible to input a command while singing.

Meanwhile, in FIG. 5, the example is illustrated in which feedback is issued when the input voice is rejected based on the voice behavior that is identified by the intelligent processing unit 230, but the intelligent processing unit 230 may reject the input voice based on the voice style that is significantly detected in the predetermined environment as described above or the estimated emotion, and cause the information processing terminal 10 to output feedback related to the rejection. Further, the intelligent processing unit 230 may determine a content of the feedback on the basis of the voice behavior, the predetermined environment as described above, a type of the emotion, or the like.

Furthermore, the intelligent processing unit 230 may similarly cause the information processing terminal 10 to output the feedback as described above on the basis of one or a combination of the content of the voice input, the content of the output information, and the style of the output information, in addition to rejecting the input voice on the basis of the style of the voice input.

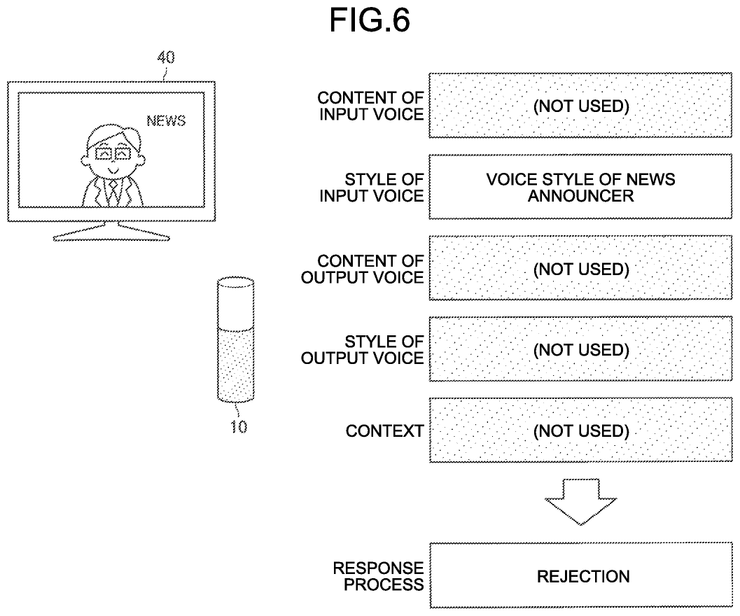

Moreover, FIG. 6 is a diagram illustrating an example of determination on right and wrong of a response based on a similarity with the voice style that is significantly detected in the predetermined environment according to the present embodiment. FIG. 6 illustrates an exemplary case in which a television device 40 located in the vicinity of the information processing terminal 10 is replaying a news program. In this case, the intelligent processing unit 230 according to the present embodiment is able to detect that the style of the input voice is similar to a voice style that is characteristic to an announcer as illustrated on the right side in the figure.

In this case, because the input voice is spoken as smooth as a professional announcer, the intelligent processing unit 230 estimates that the input voice is not input by the user and may reject the input voice. According to the above-described function of the intelligent processing unit 230 of the present embodiment, it is possible to effectively reduce the possibility that a response process is erroneously performed with respect to a voice that is output by a television device or a different agent device.

In contrast, even when the style of the input voice is similar to the voice style that is significantly detected in the predetermined environment, if the user who is estimated to have spoken the input voice is detected in a surrounding area, the intelligent processing unit 230 may accept the input voice.

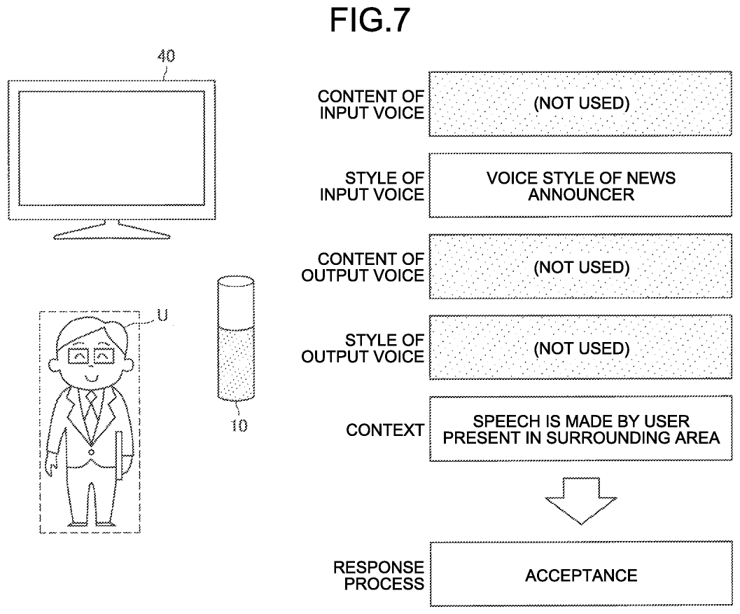

FIG. 7 illustrates an exemplary case in which the user U who can speak smoothly has spoken to the information processing terminal 10 while expecting a response process. In this case, the intelligent processing unit 230 according to the present embodiment detects that the style of the input voice is similar to the voice style that is characteristic to an announcer as illustrated on the right side in the figure.

Meanwhile, in the example illustrated in FIG. 7, unlike the case illustrated in FIG. 6, a state in which “speech is made by a user present in a surrounding area” is recognized as a context. In this case, the intelligent processing unit 230 may accept the input voice on the basis of the context and perform a response process. Incidentally, the context recognition unit 220 is able to recognize that the user is speaking by detecting a motion of a mouth or the like of the user from a captured image, for example.

In this manner, the intelligent processing unit 230 according to the present embodiment is able to improve accuracy of determination on right and wrong of a response by using the context in addition to the style of the voice input. For example, even when “a voice is input from a certain angle in an approximately vertical direction while a user is not present in a surrounding area”, the intelligent processing unit 230 is able to recognize the circumstance as the context and reject the input voice.

Thus, the exemplary case in which the intelligent processing unit 230 determines right and wrong of a response by using only the style of the input voice or by using a combination of the style of the input voice and the context has been described above. Meanwhile, another example in which the intelligent processing unit 230 determines right and wrong of a response by using only the style of the input voice includes, for example, a case in which right and wrong of a response is determined based on tone of voice as the voice style. In this case, the intelligent processing unit 230 is able to determine right and wrong of a response by learning the tone of voice of a user who has spoken a wake up word, and comparing the learned tone of voice with tone of voice of the input voice. Further, if the input voice is input from a certain input direction, such as a direction of a window, other than directions inside a room, the intelligent processing unit 230 may perform determination, such as rejection, on the input voice.

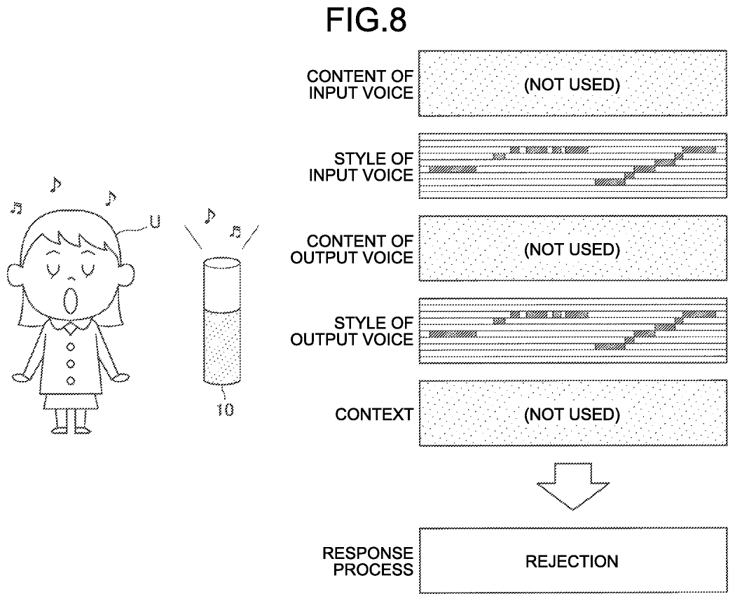

Next, determination on right and wrong of a response based on the style of the input voice and the style of the output information according to the present embodiment will be described. FIG. 8 is a diagram illustrating an example of determination on right and wrong of a response based on the style of the input voice and the style of the output information according to the present embodiment.

FIG. 8 illustrates an exemplary case in which the user U is singing in a circumstance in which the information processing terminal 10 outputs music. In this case, a melody line of the input voice and a melody line of the output voice are similar to each other as illustrated on the right side in the figure.

In this manner, if the style of the input voice and the style of the output voice are similar to each other, it is expected that the user is singing to the voice that is output from the information processing terminal 10. Therefore, the intelligent processing unit 230 rejects the input voice and need not perform a response process.

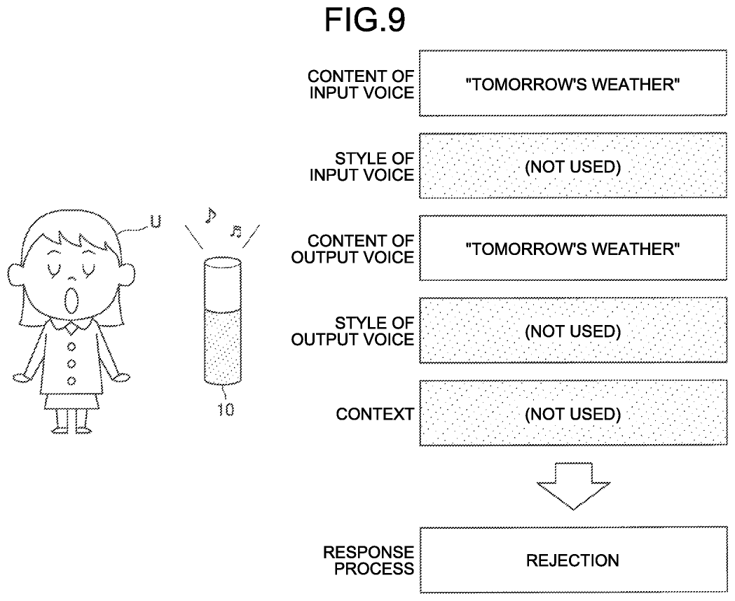

Further, the singing to the output voice as described above may be estimated on the basis of the content of input and the content of output. FIG. 9 is a diagram illustrating an example of determination on right and wrong of a response based on the content of input and the content of output according to the present embodiment.

FIG. 9 illustrates an exemplary case in which the user U is singing while the information processing terminal 10 outputs music. In this case, it is expected that the content of the input voice and the content of the output voice, i.e., song lyrics, approximately match with each other.

Therefore, if the content of the input voice and the content of the output voice are similar to each other, the intelligent processing unit 230 rejects the input voice and need not perform a response process. Meanwhile, if, for example, a content of an input gesture and a content of an output gesture instead of voices are similar to each other, the intelligent processing unit 230 may perform control, such as rejection, on the input gesture.

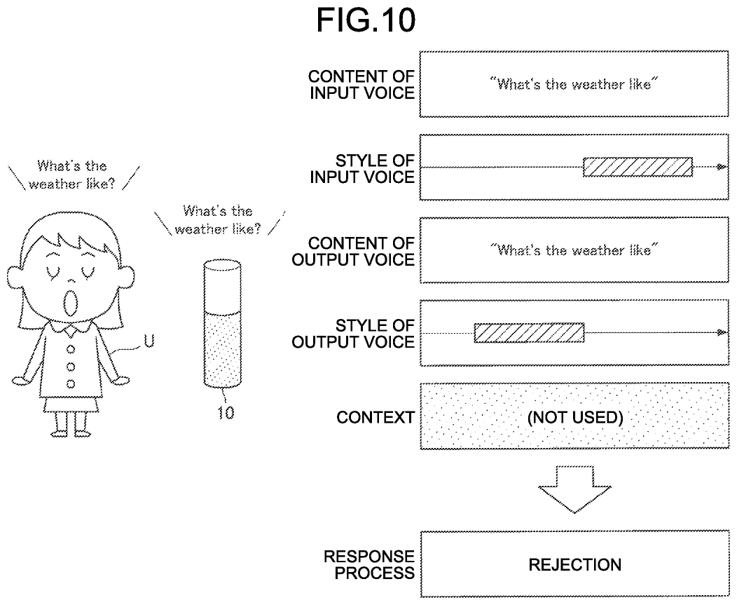

Next, determination on right and wrong of a response based on the style of the input voice, the content of the input voice, the style of the output voice, and the content of the output voice will be described. FIG. 10 is a diagram illustrating an example of determination on right and wrong of a response based on the style of the input voice, the content of the input voice, the style of the output voice, and the content of the output voice.

FIG. 10 illustrates an exemplary case in which the user U is repeating an English sentence while the information processing terminal 10 is output the English sentence. In this case, the content of the input voice and the content of the output voice approximately match with each other, similarly to the case illustrated in FIG. 9.

Further, in the example as illustrated in FIG. 10, it is expected that an input timing of the input voice is slightly delayed from an output timing of the output voice.

In this manner, if it is estimated that the input voice is repeating the output voice on the basis of the style of the input voice, the content of the input voice, the style of the output voice, and the content of the output voice, the intelligent processing unit 230 rejects the input voice and need not perform a response process.

According to the above-described function of the intelligent processing unit 230 of the present embodiment, it is possible to effectively reduce the possibility that speech of a user who is practicing a language is erroneously accepted and response operation that is not expected by the user is performed.

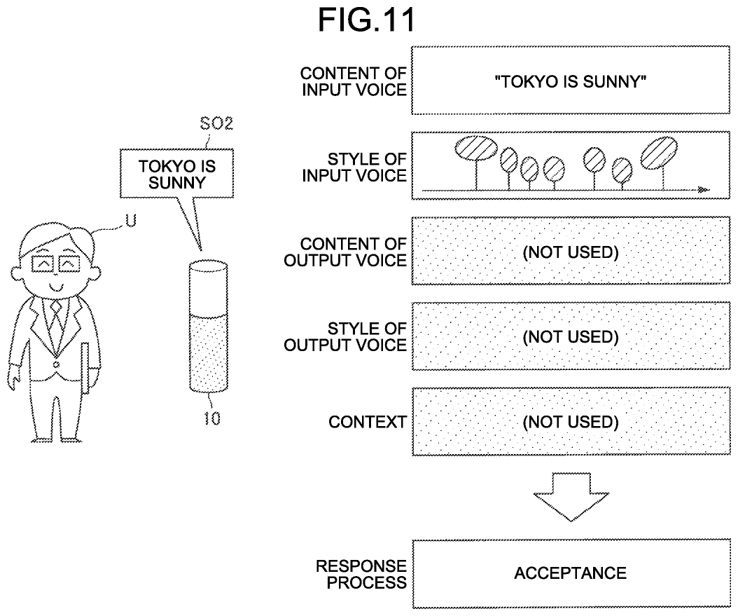

Furthermore, FIG. 11 is a diagram illustrating another example of determination on right and wrong of a response based on the style of the input voice and the content of the input voice according to the present embodiment.

FIG. 11 illustrates an exemplary case in which the user U speaks a word asking for weather in Tokyo to the information processing terminal 10. In the example illustrated in FIG. 11, the intelligent processing unit 230 acquires voice pitch as the style of the input voice.

In this case, if the input voice of the user U is intended to ask for information, the style of the input voice is expected to be a question that ends with rising intonation and the content of the input voice is expected to end with a sentence in an end-form.

Therefore, if the style of the input voice is a question and the content of the input voice ends with a sentence in the end-form, the intelligent processing unit 230 according to the present embodiment may accept the input voice and perform a response process. In the example illustrated in FIG. 11, the intelligent processing unit 230 causes the information processing terminal 10 to output voice speech SO2 for notifying that Tokyo is sunny. In contrast, if the style of the input voice is an assertion that ends with falling intonation, the intelligent processing unit 230 may reject the input voice.

In this manner, according to the intelligent processing unit 230 of the present embodiment, it is possible to determine whether the input voice is spoken to make an inquiry on the basis of the content of the input voice and the style of the input voice.

Thus, determination on right and wrong of a response based on the style of the input voice and the content of the input voice according to the present embodiment has been described above. Meanwhile, another example in which the intelligent processing unit 230 determines right and wrong of a response based on the style of the input voice and the content of the input voice includes, for example, a case in which even when the voice behavior of “singing” is identified from the style of the voice input, lyrics of the song that the user is singing are not existing lyrics with reference to the content of the input voice, and a case in which the input voice is accepted by taking into account the possibility that the user is performing voice input to the information processing terminal 10 while singing.

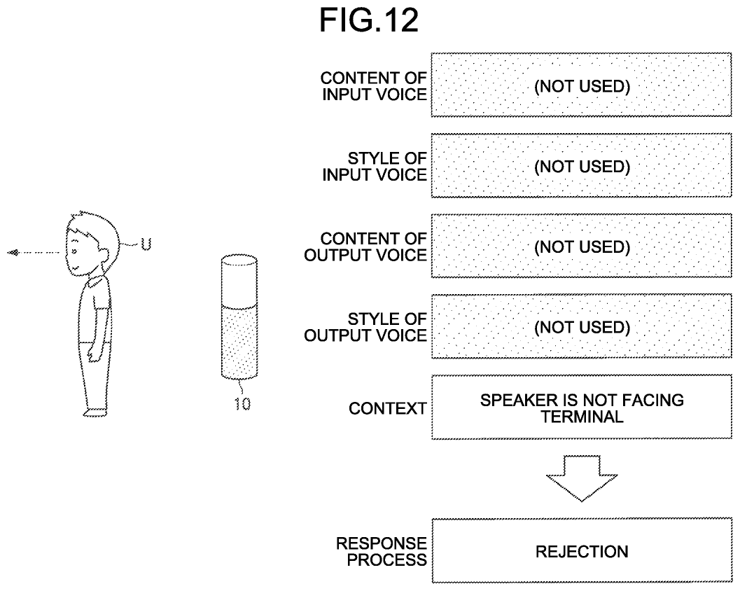

Next, determination on right and wrong of a response based on the context according to the present embodiment will be described. FIG. 12 is a diagram illustrating an example of determination on right and wrong of a response based on the context according to the present embodiment.

FIG. 12 illustrates an exemplary case in which the user U speaks with his/her back to the information processing terminal 10. In this case, the intelligent processing unit 230 may estimate that the user U is talking with another person, talking over the phone, or talking to him/herself on the basis of detection of the context in which the user U who is a speaker of the input voice is not facing the direction of the information processing terminal 10, and reject the input voice.

According to the above-described function of the intelligent processing unit 230 of the present embodiment, it is possible to effectively reduce the possibility that speech of a user who does not expect a response process is erroneously accepted and conversation of the user is disturbed.

Thus, determination on right and wrong of a response using only the context according to the present embodiment has been described above. Meanwhile, another example in which the intelligent processing unit 230 determines right and wrong of a response form only the context includes a case in which the user faces a direction of a different agent, a case in which the user has a predetermined attribute, such as an unregistered user, a case in which the user is present in a predetermined place, a case in which the user performs a predetermined behavior, and the like.

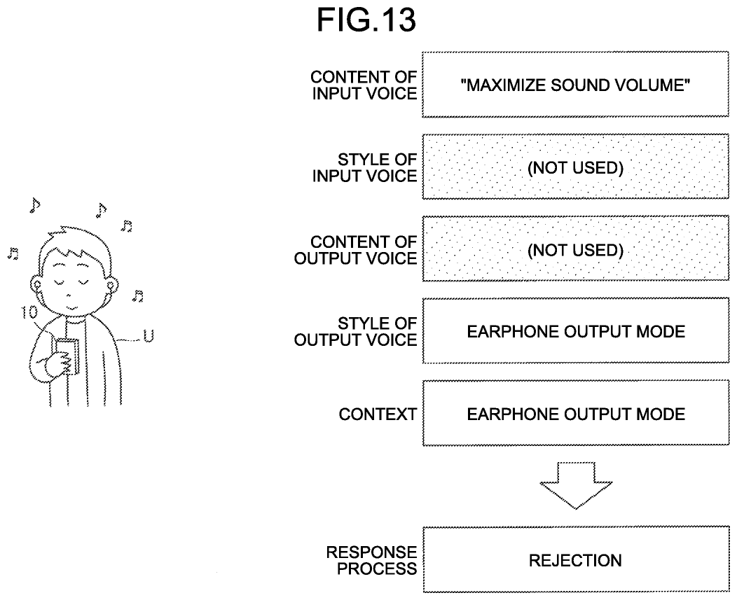

Next, determination on right and wrong of a response based on the context and the content of the input voice according to the present embodiment will be described. FIG. 13 to FIG. 18 are diagrams illustrating an example of determination on right and wrong of a response based on the context and the content of the input voice according to the present embodiment.

FIG. 13 illustrates an exemplary case in which an input voice with a content of “maximize sound volume” is recognized while the user U is wearing earphones. Meanwhile, FIG. 13 illustrates an exemplary case in which the information processing terminal 10 is a smartphone.

In this case, the intelligent processing unit 230 may reject the input voice related to adjustment of sound volume on the basis of recognition of the context in which the information processing terminal 10 is in an earphone output mode. This rejection is to eliminate the possibility that the ears of the user U are damaged by rapidly increasing the sound volume while the user U is wearing earphones.

Meanwhile, as illustrated in the drawing, information on various output modes related to earphone output or the like may be detected as one of the styles of the output voice, in addition to being recognized as the context.

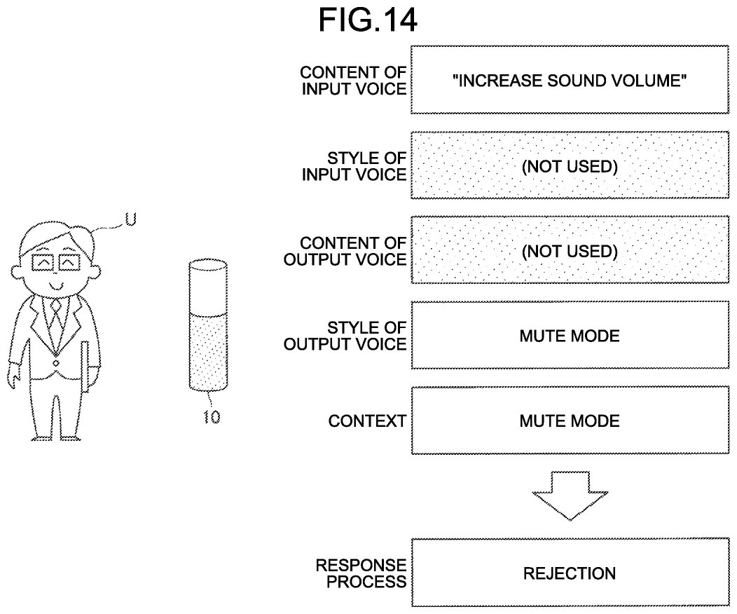

FIG. 14 illustrates an exemplary case in which an input voice with a content of “increase sound volume” is recognized while the information processing terminal 10 is in a mute mode.

In this case, the intelligent processing unit 230 may reject the input voice related to adjustment of the sound volume on the basis of recognition of the context or the style of the output voice in which the information processing terminal 10 is in the mute mode. This rejection is to eliminate the possibility that the mute mode is erroneously cancelled when the input voice related to the adjustment of the sound volume is not spoken by the user.

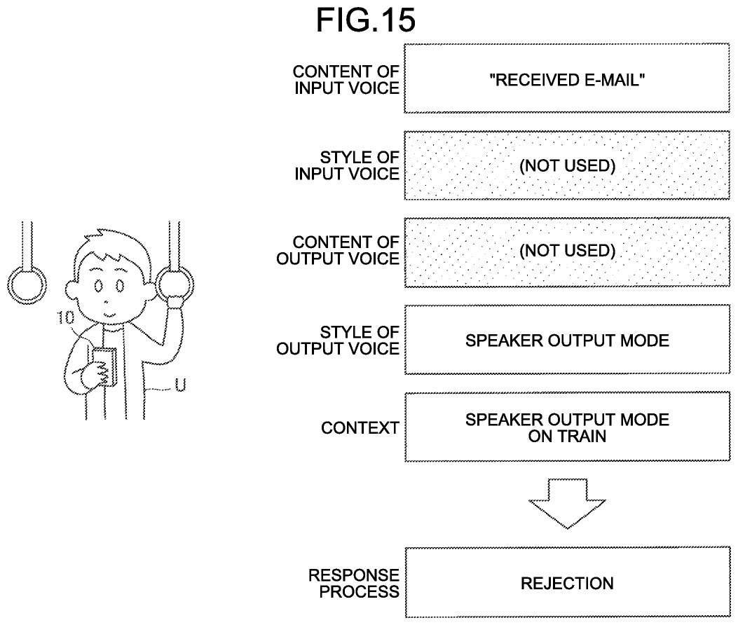

Furthermore, FIG. 15 illustrates an exemplary case in which an input voice with a content of “received e-mail” is recognized while a state in which the user U is on a train is detected as a context. Moreover, in the example illustrated in FIG. 15, a state in which the information processing terminal 10 is in a speaker output mode is detected as the context or the style of the output voice.

In this case, the intelligent processing unit 230 may reject the input voice and need not perform a response process in order to prevent a content of an e-mail that may include personal information from being output via a speaker on the train. In this manner, the intelligent processing unit 230 according to the present embodiment is able to reject a command (input voice) that is not acceptable depending on the operation mode.

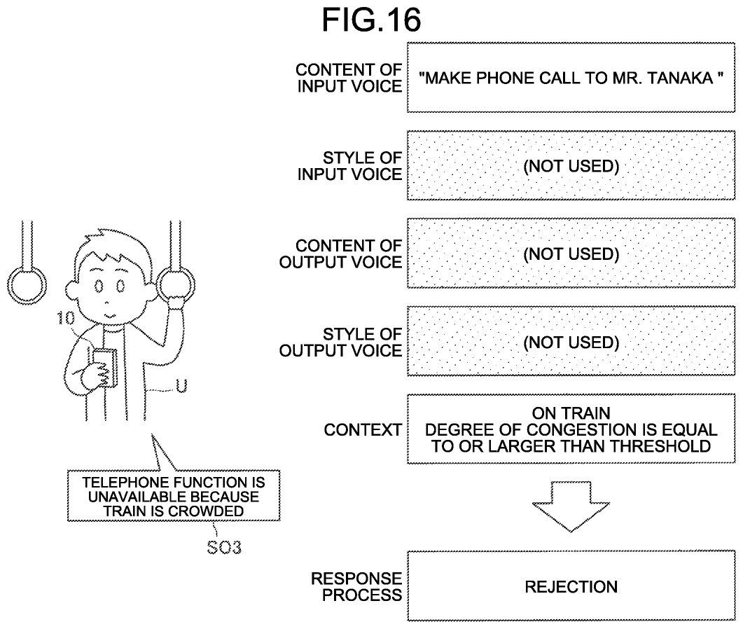

Furthermore, when rejecting the command depending on the operation mode, the intelligent processing unit 230 may notify the user of a reason for the rejection of the command. FIG. 16 illustrates an exemplary case in which an input voice with a content of “make a phone call to Mr. Tanaka” is recognized while a state in which the user U is on a train and a degree of congestion in the train is equal to or larger than a threshold is detected as a context.

In this case, the intelligent processing unit 230 may reject the input voice so as not to disturb other passengers around the user. In addition, for example, as illustrated in the figure, the intelligent processing unit 230 may notify, by voice speech SO3, the user U that a telephone function is unavailable because the train is crowded. In this manner, by causing the intelligent processing unit 230 to control feedback related to the reason for the rejection of the command, the user is able to naturally learn that a specific command is unavailable in a specific operation mode. Meanwhile, in a case in which the degree of congestion in the train is extremely high, the intelligent processing unit 230 may display visual information indicating that the telephone function is unavailable.

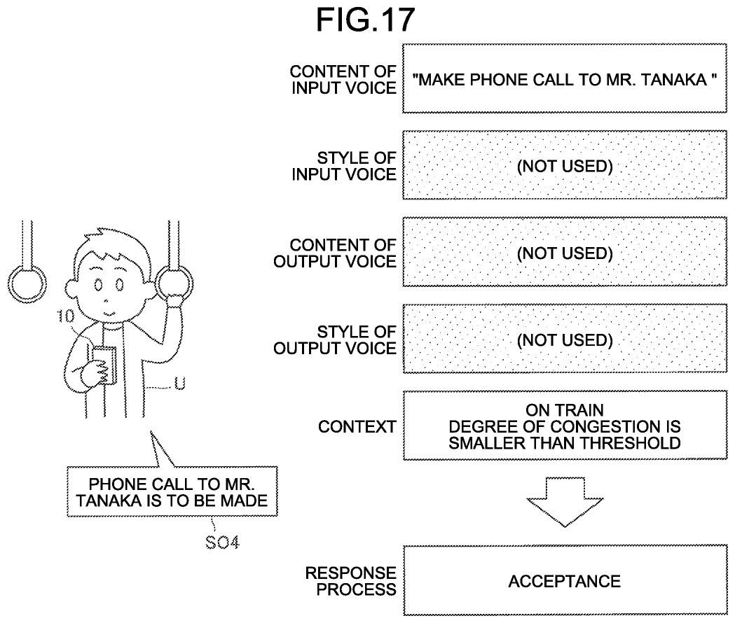

Furthermore, FIG. 17 illustrates an exemplary case in which an input voice with a content of “make a phone call to Mr. Tanaka” is recognized while a state in which the user U is on a train and a degree of congestion in the train is smaller than the threshold is detected as a context.

In this case, the intelligent processing unit 230 may accept the input voice and perform a response process because the train is not crowded and it is less likely to disturb other passengers around the user. In the example illustrated in FIG. 17, the intelligent processing unit 230 causes the information processing terminal 10 to output voice speech SO4 indicating that a phone call to Mr. Tanaka is to be made, and thereafter performs a process of controlling phone call making.

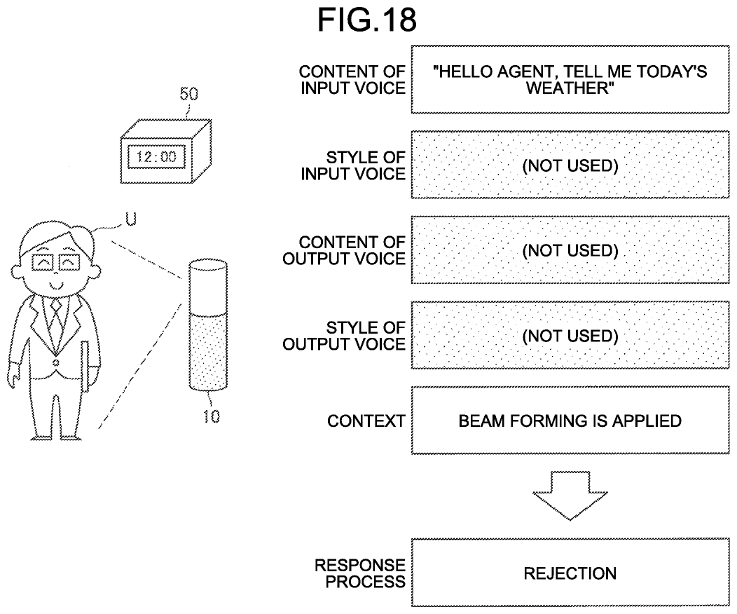

Moreover, FIG. 18 illustrates an exemplary case in which an input voice with a content including a wake up word for the different agent device 50 is recognized while a state in which beamforming is applied to the user U is detected as a context.

In this case, even when the beamforming is applied to the user U, the intelligent processing unit 230 may reject the input voice and need not perform a response process on the basis of the recognition of the wake up word as described above. According to the above-described function of the intelligent processing unit 230 of the present embodiment, even when the user selectively uses a plurality of agent devices, it is possible to eliminate the possibility that a response process that is not indented by the user is performed. Meanwhile, the intelligent processing unit 230 is able to perform the same determination as described above not only when the beamforming is applied to the user, but also when the beamforming is applied to a certain direction with respect to the information processing terminal 10.

Thus, determination on right and wrong of a response based on the content of the input voice and the context according to the present embodiment has been described above. Meanwhile, another example in which the intelligent processing unit 230 determines right and wrong of a response based on the content of the input voice and the context includes, for example, a case in which, when an input voice with a content indicating settlement is recognized while a state in which a user is identified as a child is recognized as a context, the input voice is rejected by taking into account the possibility that the capacity to take responsibility or the capacity for judgement is insufficient.

As described above, the intelligent processing unit 230 according to the present embodiment is able to realize determination on right and wrong of a response with high accuracy on the basis of any or a combination of the content of the input voice, the style of the input voice, the content of the output voice, the style of the output voice, and the context.

<<1.7. Flow of Operation>>

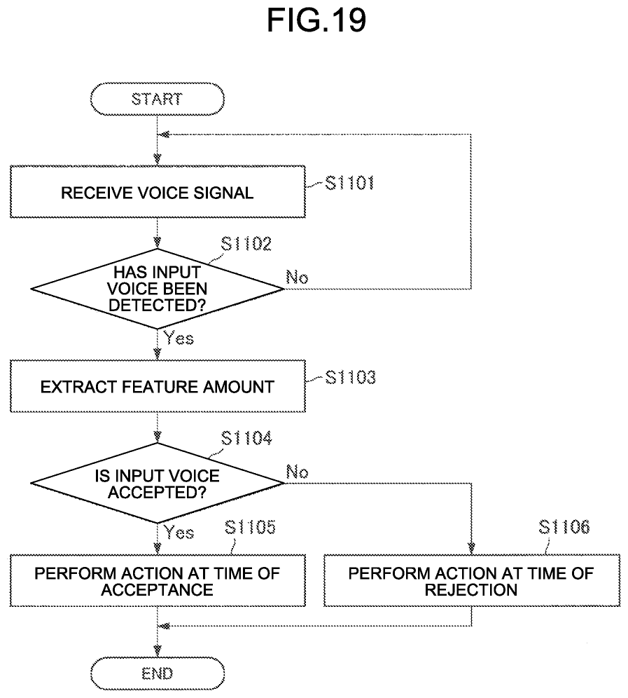

Next, the flow of operation performed by the information processing server 20 according to the present embodiment will be described in detail below. FIG. 19 is a flowchart illustrating the flow of the operation performed by the information processing server 20 according to the present embodiment.

With reference to FIG. 19, first, the terminal communication unit 250 receives a voice signal collected by the information processing terminal 10 (S1101).

Subsequently, the intelligent processing unit 230 determines whether the voice recognition unit 210 has detected an input voice (S1102).

Here, if the voice recognition unit 210 has not detected the input voice (S1102: No), the information processing server 20 returns to Step S1101.

In contrast, if the voice recognition unit 210 has detected the input voice (S1102: Yes), the intelligent processing unit 230 extracts a feature amount of the detected input voice (S1103). Further, the intelligent processing unit 230 may extract a feature amount of an output voice.

Subsequently, the intelligent processing unit 230 determines whether to accept the input voice on the basis of the feature amount extracted at Step S1103 (S1104).

Here, if the input voice is to be accepted (S1104: Yes), the intelligent processing unit 230 performs an action at the time of acceptance on the basis of the input voice (S1105).

In contrast, if the input voice is to be rejected (S1104: No), the intelligent processing unit 230 performs an action at the time of rejection on the basis of the input voice (S1106).

### 2. Hardware Configuration Example

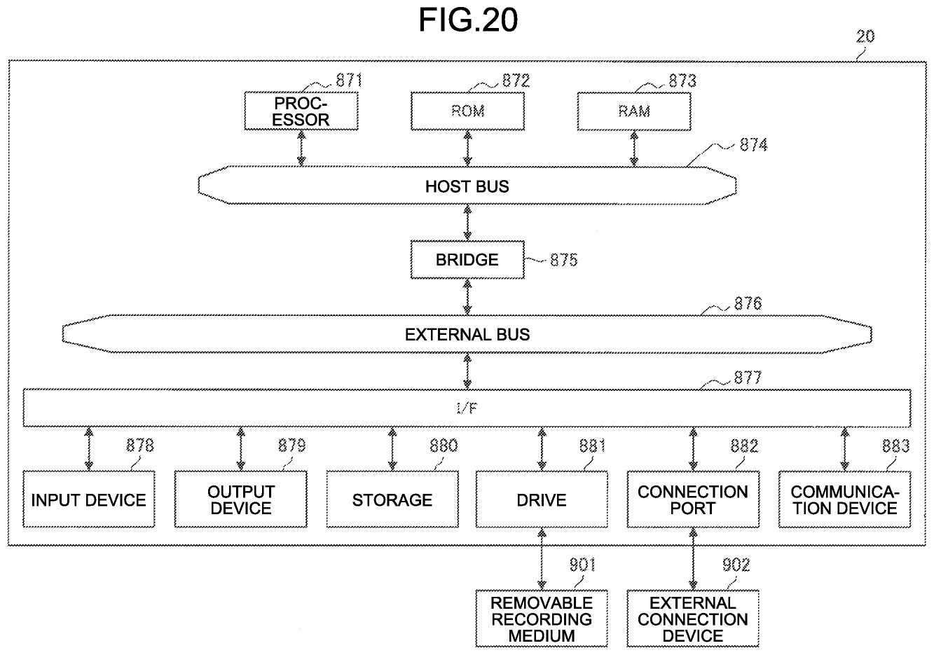

Next, a hardware configuration example of the information processing server 20 according to one embodiment of the present disclosure will be described. FIG. 20 is a block diagram illustrating an example of the hardware configuration of the information processing server 20 according to one embodiment of the present disclosure. With reference to FIG. 20, the information processing server 20 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Meanwhile, the hardware configuration described herein is one example, and a part of the structural elements may be omitted. Further, it may be possible to further include structural elements other than the structural elements described herein.

(Processor 871)

The processor 871 functions as, for example, an arithmetic processing device or a control device, and controls all or a part of operation of each of the structural elements on the basis of various programs that are recorded in the ROM 872, the RAM 873, the storage 880, or a removable recording medium 901.

(ROM 872 and RAM 873)

The ROM 872 is a means for storing programs read by the processor 871, data used for calculations, and the like. The RAM 873 temporarily or permanently stores therein, for example, programs read by the processor 871, various parameters that are appropriately changed during execution of the programs, and the like.

(Host Bus 874, Bridge 875, External Bus 876, and Interface 877)

The processor 871, the ROM 872, and the RAM 873 are connected to one another via the host bus 874 capable of performing high-speed data transmission, for example. In addition, the host bus 874 is connected to the external bus 876 whose data transmission speed is relatively low, via the bridge 875, for example. Further, the external bus 876 is connected to various structural elements via the interface 877.

(Input Device 878)

As the input device 878, for example, a mouse, a keyboard, a touch panel, a button, a switch, a lever, or the like is used. Further, as the input device 878, a remote controller (hereinafter, controller) capable of transmitting control signals using infrared light or other radio waves may be used. Furthermore, the input device 878 includes a voice input device, such as a microphone.

(Output Device 879)

The output device 879 is a device, such as a display device including a Cathode Ray Tube (CRT), an LCD, and an organic EL, an audio output device including a speaker and a headphone, a printer, a mobile phone, or a facsimile, that is able to visually or auditorily notify the user of acquired information. Further, the output device 879 according to the present disclosure includes various vibration devices capable of outputting tactile stimulation.

(Storage 880)

The storage 880 is a device for storing various kinds of data. As the storage 880, for example, a magnetic storage device, such as a hard disk drive (HDD), a semiconductor storage device, an optical storage device, a magneto optical storage device, or the like may be used.

(Drive 881)

The drive 881 is a device that reads information recorded in the removable recording medium 901, such as a magnetic disk, an optical disk, a magneto optical disk, or a semiconductor memory, or writes information to the removable recording medium 901.

(Removable Recording Medium 901)

The removable recording medium 901 is, for example, various semiconductor storage media, such as a DVD medium, a Blu-ray (registered trademark) medium, or an HD DVD medium. The removable recording medium 901 may be, of course, an IC card on which a contactless IC chip is mounted, an electronic device, or the like, for example.

(Connection Port 882)

The connection port 882 is a port, such as a Universal Serial Bus (USB) port, an IEEE 1394 port, a Small Computer System Interface (SCSI), an RS-232C port, or an optical audio terminal, for connecting an external connection device 902.

(External Connection Device 902)

The external connection device 902 is, for example, a printer, a mobile music player, a digital camera, a digital video camera, an IC recorder, or the like.

(Communication Device 883)

The communication device 883 is a communication device for connecting to a network, and is, for example, a communication card for a wired or wireless LAN, Bluetooth (registered trademark), or Wireless USB (WUSB), a router for optical communication, a router for Asymmetric Digital Subscriber Line (ADSL), a modem for various kinds of communication, or the like.

### 3. Conclusion

As described above, the information processing server 20 according to one embodiment of the present disclosure includes the intelligent processing unit 230 that determines whether to perform a response process on an input voice on the basis of at least one of the style of the input voice and the style of the output voice. With this configuration, it is possible to determine right and wrong of a response to the input voice with high accuracy.

While the preferred embodiments of the present disclosure have been described in detail above with reference to the accompanying drawings, the technical scope of the present disclosure is not limited to the examples as described above. It is obvious that a person skilled in the technical field of the present disclosure may conceive various alternations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Furthermore, it is possible to generate a program that causes hardware, such as a CPU, a ROM, and a ROM, incorporated in a computer to implement the same functions as those of the information processing server 20, and it is possible to provide a computer readable recording medium in which the program is stored.

Moreover, each of steps in the processes performed by the information processing server 20 of the present specification need not always be processed in chronological order as illustrated in the flowchart. For example, each of steps related to the processes performed by the information processing server 20 may be executed in different order from the order illustrated in the flowchart, or may be performed in a parallel manner

The following configurations are also within the technical scope of the present disclosure.

(1)

An information processing apparatus comprising:

an intelligent processing unit configured to determine whether to perform a response process on an input voice on the basis of at least one of a style of the input voice and a style of an output voice.

(2)

The information processing apparatus according to (1), wherein the intelligent processing unit determines whether the input voice is input with intention for the response process on the basis of the style of the input voice, and determines whether to perform the response process on the basis of a result of the determination.

(3)

The information processing apparatus according to (1) or (2), wherein the intelligent processing unit identifies a voice behavior that is a cause of input of the input voice on the basis of the style of the input voice, and determines whether to perform the response process on the basis of the voice behavior.

(4)

The information processing apparatus according to (3), wherein if the voice behavior is not recognized as being intended for the response process, the intelligent processing unit rejects the input voice and does not perform the response process.

(5)

The information processing apparatus according to (4), wherein the voice behavior that is not recognized as being intended for the response process includes any of singing, reading aloud, and emotional expression.

(6)

The information processing apparatus according to any one of (1) to (5), wherein the intelligent processing unit determines whether the style of the input voice is similar to a voice style that is significantly detected in a predetermined environment, and determines whether to perform the response process on the basis of a result of the determination.

(7)

The information processing apparatus according to (6), wherein if a feature extracted from the style of the input voice is similar to a voice feature that is significantly detected in a predetermined environment, the intelligent processing unit rejects the input voice and does not perform the response process.

(8)

The information processing apparatus according to (7), wherein if the feature extracted from the style of the input voice is similar to the voice feature that is significantly detected in the predetermined environment and if presence of a user who is estimated to have spoken the input voice is detected, the intelligent processing unit accepts the input voice and performs the response process.

(9)

The information processing apparatus according to any one of (1) to (8), wherein if the style of the input voice and the style of the output voice are similar to each other, the intelligent processing unit rejects the input voice and does not perform the response process.

(10)

The information processing apparatus according to any one of (1) to (9), wherein the style of the output voice includes setting of an output mode.

(11)

The information processing apparatus according to any one of (1) to (10), wherein the intelligent processing unit determines whether to perform the response process further based on a content of the input voice.

(12)

The information processing apparatus according to (11), wherein if the style of the input voice is a question and the content of the input voice ends with a sentence in an end-form, the intelligent processing unit accepts the input voice and performs the response process.

(13)

The information processing apparatus according to (11) or (12), wherein if the content of the input voice includes a wake up word for executing a function of a different terminal, the intelligent processing unit rejects the input voice and does not perform the response process.

(14)

The information processing apparatus according to any one of (1) to (12), wherein the intelligent processing unit determines whether to perform the response process further based on a content of the output voice.

(15)

The information processing apparatus according to (13), wherein if the content of the input voice and a content of the output voice are similar to each other, the intelligent processing unit rejects the input voice and does not perform the response process.

(16)

The information processing apparatus according to (13) or (14), wherein if it is estimated that the input voice is repeating the output voice, the intelligent processing unit rejects the input voice and does not perform the response process.

(17)

The information processing apparatus according to any one of (1) to (15), wherein the intelligent processing unit determines whether to perform the response process further based on a detected context.

(18)

The information processing apparatus according to any one of (1) to (17), when rejecting the input voice, the intelligent processing unit outputs feedback related to rejection of the input voice.

(19)

The information processing apparatus according to any one of (1) to (18), wherein the style of the input voice includes at least one of voice volume, voice pitch, voice sound, and rhythm.

(20)

An information processing method comprising: determining, by a processor, whether to perform a response process on an input voice on the basis of at least one of a style of the input voice and a style of an output voice.

### REFERENCE SIGNS LIST

10 information processing terminal

110 display unit

120 voice output unit

130 voice input unit

140 imaging unit

150 sensor unit

160 control unit

170 server communication unit

20 information processing server

210 voice recognition unit

220 context recognition unit

230 intelligent processing unit

240 output control unit

250 terminal communication unit

1. An information processing apparatus comprising:
an intelligent processing unit configured to determine whether to perform a response process on an input voice on the basis of at least one of a style of the input voice and a style of an output voice.

2. The information processing apparatus according to claim 1, wherein the intelligent processing unit determines whether the input voice is input with intention for the response process on the basis of the style of the input voice, and determines whether to perform the response process on the basis of a result of the determination.

3. The information processing apparatus according to claim 1, wherein the intelligent processing unit identifies a voice behavior that is a cause of input of the input voice on the basis of the style of the input voice, and determines whether to perform the response process on the basis of the voice behavior.

4. The information processing apparatus according to claim 3, wherein if the voice behavior is not recognized as being intended for the response process, the intelligent processing unit rejects the input voice and does not perform the response process.

5. The information processing apparatus according to claim 4, wherein the voice behavior that is not recognized as being intended for the response process includes any of singing, reading aloud, and emotional expression.

6. The information processing apparatus according to claim 1, wherein the intelligent processing unit determines whether the style of the input voice is similar to a voice style that is significantly detected in a predetermined environment, and determines whether to perform the response process on the basis of a result of the determination.

7. The information processing apparatus according to claim 6, wherein if a feature extracted from the style of the input voice is similar to a voice feature that is significantly detected in a predetermined environment, the intelligent processing unit rejects the input voice and does not perform the response process.

8. The information processing apparatus according to claim 7, wherein if the feature extracted from the style of the input voice is similar to the voice feature that is significantly detected in the predetermined environment and if presence of a user who is estimated to have spoken the input voice is detected, the intelligent processing unit accepts the input voice and performs the response process.

9. The information processing apparatus according to claim 1, wherein if the style of the input voice and the style of the output voice are similar to each other, the intelligent processing unit rejects the input voice and does not perform the response process.

10. The information processing apparatus according to claim 1, wherein the style of the output voice includes setting of an output mode.

11. The information processing apparatus according to claim 1, wherein the intelligent processing unit determines whether to perform the response process further based on a content of the input voice.

12. The information processing apparatus according to claim 11, wherein if the style of the input voice is a question and the content of the input voice ends with a sentence in an end-form, the intelligent processing unit accepts the input voice and performs the response process.

13. The information processing apparatus according to claim 11, wherein if the content of the input voice includes a wake up word for executing a function of a different terminal, the intelligent processing unit rejects the input voice and does not perform the response process.

14. The information processing apparatus according to claim 1, wherein the intelligent processing unit determines whether to perform the response process further based on a content of the output voice.

15. The information processing apparatus according to claim 13, wherein if the content of the input voice and a content of the output voice are similar to each other, the intelligent processing unit rejects the input voice and does not perform the response process.

16. The information processing apparatus according to claim 13, wherein if it is estimated that the input voice is repeating the output voice, the intelligent processing unit rejects the input voice and does not perform the response process.

17. The information processing apparatus according to claim 1, wherein the intelligent processing unit determines whether to perform the response process further based on a detected context.

18. The information processing apparatus according to claim 1, when rejecting the input voice, the intelligent processing unit outputs feedback related to rejection of the input voice.

19. The information processing apparatus according to claim 1, wherein the style of the input voice includes at least one of voice volume, voice pitch, voice sound, and rhythm.

20. An information processing method comprising:
determining, by a processor, whether to perform a response process on an input voice on the basis of at least one of a style of the input voice and a style of an output voice.
